(19) United States
(12) Patent Application Publication
(10) Pub. No.: US 2007/0056016 A1
(43) Pub. Date: Mar. 8, 2007

(54) Mobile video adapter stick

(75) Inventor: Yu-Chiang Shih, Taipei Hsien (TW)

Correspondence Address: BIRCH STEWART KOLASCH & BIRCH, PO BOX 747, FALLS CHURCH, VA, 22040-0747, US

(73) Assignee: ANIMATION TECHNOLOGIES INC.

(21) Appl. No.: 11/486,073

(22) Filed: Jul. 14, 2006

(30) Foreign Application Priority Data
Sep. 8, 2005 (TW) 094130963

(51) Int. Cl. H04N 7/16; H04N 7/173; H04N 5/91; H04N 7/00

(52) U.S. Cl. 725/134; 725/62; 725/142; 386/46

(57) ABSTRACT

A mobile video adapter stick includes a housing, which has a front transmission interface for connection to a computer, a plurality of air vents in communication between the inside space and the atmosphere, and rear adapter interface for connection to an audio and video signal source, a circuit board mounted inside the housing and electrically connected to the transmission interface and the adapter interface for processing inputted audio and video signals received from the adapter interface for output through the transmission interface, and a cooling fan mounted inside the housing for cooling the video processing chip of the circuit board.

### BACKGROUND OF THE INVENTION

1. Field of the Invention

The present invention relates to a mobile video adapter device for connecting an audio and video signal source to a computer and, more particularly, to a mobile video adapter stick, which has a cooling fan mounted on the inside for causing a circulation of air through the housing thereof to dissipate heat from the internal circuit board during its operation.

2. Description of the Related Art

Following fast development of audio and video technology, advanced TV, computer, VCD/DVD player, MP3 player, and other different audio/video playing apparatus have been continuously created and have appeared on the market. These devices are independent devices. When in use, transmission cables or the like shall be used to connect various audio and video devices into an audio and video system so that audio and/or video signals from the audio and/or video source can be outputted through the display screen and the speakers. Currently market video output devices, such as TV screens or computer screens, are designed to fit a particular play mode. A TV screen is connected to a video box, for example, a set-top box by means of a signal line for audio and video output. A computer screen must be connected to a computer so that the computer can output storage audio and video data through the computer screen. Following fast development of network technology, a computer can receive audio and video signals from a remote signal source through the Internet, or pick up surrounding images through a web cam for further transmission to a remote computer through the Internet. In addition to the function for output of audio and video signals received from a computer, a modem computer screen can also be used as a TV screen for output of TV signals. However, TV and computer belong to different categories and use different audio/video receiving and transmitting programs. Therefore, it is necessary to install a TV box or TV card in a computer to convert audio and video signals into computer readable signals so that the user can watch TV programs through the computer.

There are commercial computers that have a TV card installed in the mainframe for processing audio and video signals. When installing a TV card in a computer, the operator must detach the mainframe of the computer so that the TV card can be inserted into a corresponding slot at the motherboard. When wishing to install a TV card in a computer, the motherboard of the computer must have a slot that fits the TV card. This TV card installation procedure is complicated. When the TV card failed, the worker must detach the mainframe of the computer again so that a failed TV card can be detached from the motherboard for repair or replacement.

A popular TV box is a rectangular box that houses a circuit board for converting analog audio and video signals into digital audio and video signals.

FIG. 8 is an exploded view of a conventional TV box. As illustrated, the TV box comprises a housing A formed of a top cover A1 and a bottom cover shell A2, a storage device E mounted inside the housing A, a control panel B fastened to the front side of the housing A, an adapter circuit board B1 and a fan B2 mounted on the back side of the control panel B, a first connector B3 of IDE interface and a second connector B4 of USB interface mounted on the front side of the control panel B and electrically connected to the adapter circuit board B1, a selector switch B5 and a power input terminal B6 mounted on the front side of the control panel B and electrically connected to the adapter circuit board B1, a third connector B11 of IDE interface and a fourth connector B12 of USB interface and a power output connector B13 respectively mounted in the adapter circuit board B1 inside the housing A, and a bus line C and USB signal lines D respectively connected between an IDE interface connector E1, a USB interface connector E2 and a power input connector E3 of the storage device E and the third connector B11, the fourth connector B12 and the power output connector B13 at the adapter circuit board B1. By means of switching the selector switch B5, the first connector B3 or the second connector B4 is electrically connected to the computer for signal transmission.

The aforesaid conventional TV box has numerous drawbacks as follows:

1. The TV box is big-sized, requiring much computer space. Further, the TV box is not a mobile design. After installation of the TV box, the user cannot remove the TV box from the computer for use in another computer without detaching the mainframe of the computer.

2. The TV box is big-sized and holds a number of component parts. During operation of the TV box, the internal temperature is high, and the high temperature of the TV box may affect the affect the performance of surrounding computer peripheral apparatus.

3. Because the TV box design is big-sized and uses many component parts, it takes much time and labor to fabricate and install the TV box, resulting in a high manufacturing cost.

4. Because the fan is mounted on the back side of the control panel near one lateral side, the fan cannot cause a circulation of air through the housing, resulting in low heat dissipation efficiency and shortening of the working life of the related component parts.

5. The adapter circuit board of the TV box has a video processing chip that generates heat at about 85° C.˜89° C. during operation. Because of low heat dissipation efficiency, the TV box cannot effectively lower the temperature of the video processing chip during its operation, and the high temperature may cause instability or failure of the video processing chip.

Therefore, it is desirable to provide a video adapter device that eliminates the aforesaid drawbacks.

### SUMMARY OF THE INVENTION

The present invention has been accomplished under the circumstances in view. It is main object of the present invention to provide a mobile video adapter stick, which is small-sized, convenient to install, and inexpensive to manufacture. It is another object of the present invention to provide a mobile video adapter stick, which dissipates heat from the video processing chip of the internal circuit board during the operation, thereby prolonging the working life of the internal circuit board. To achieve these and other objects of the present invention, the mobile video adapter stick comprises a housing, a circuit board, and at least one cooling fan. The housing has an accommodation chamber, a connection portion disposed at the front side of the accommodation chamber, a transmission interface set in the connection portion for connection to a computer, a plurality of air vents disposed adjacent to the connection portion in communication between the accommodation chamber and the atmosphere, and an adapter interface disposed at the rear side of the accommodation chamber for connection to an audio and video signal source. The circuit board is mounted in the accommodation chamber inside the housing and electrically connected to the transmission interface and the adapter interface for processing inputted audio and video signals received from the adapter interface for output through the transmission interface. The circuit board comprises at least one video processing chip. The at least one cooling fan is respectively mounted in the accommodation chamber inside the housing for cooling the at least one video processing chip and the circuit board.

### BRIEF DESCRIPTION OF THE DRAWINGS

FIG. 1 is an elevational view of a mobile video adapter stick in accordance with a first embodiment of the present invention.

FIG. 2 is an exploded view of the mobile video adapter stick in accordance with the first embodiment of the present invention.

FIG. 3 is a sectional side view of the mobile video adapter stick in accordance with the first embodiment of the present invention.

FIG. 4 is a schematic sectional side view of the first embodiment of the present invention, showing the flow path of the fan air.

FIG. 5 is a top view of the mobile video adapter stick in accordance with the first embodiment of the present invention.

FIG. 6 is an elevational view of a mobile video adapter stick in accordance with a second embodiment of the present invention.

FIG. 7 is a sectional side view of a mobile video adapter stick in accordance with a third embodiment of the present invention.

FIG. 8 is an exploded view of a conventional TV box.

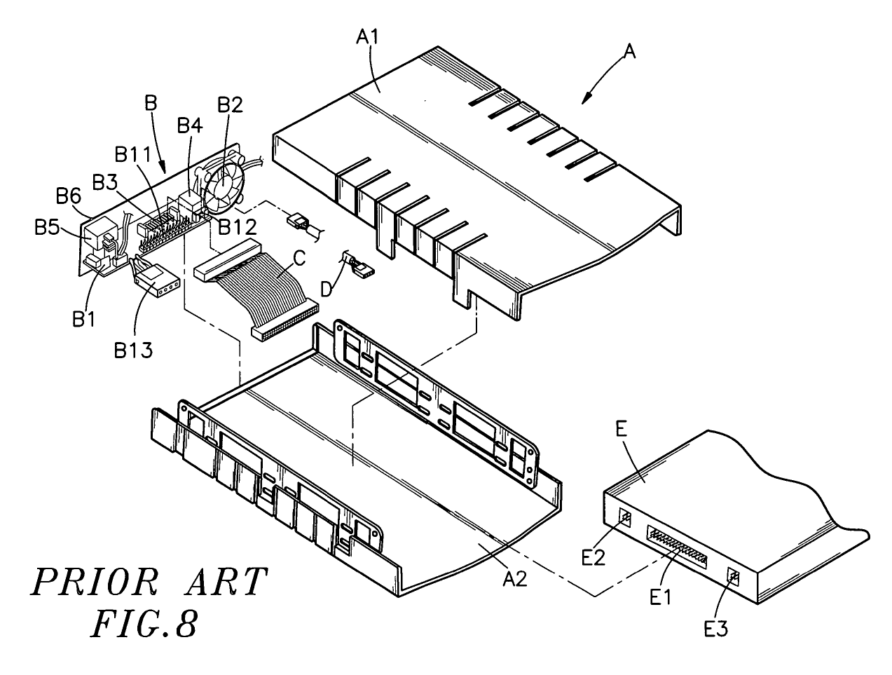

### DETAILED DESCRIPTION OF THE INVENTION

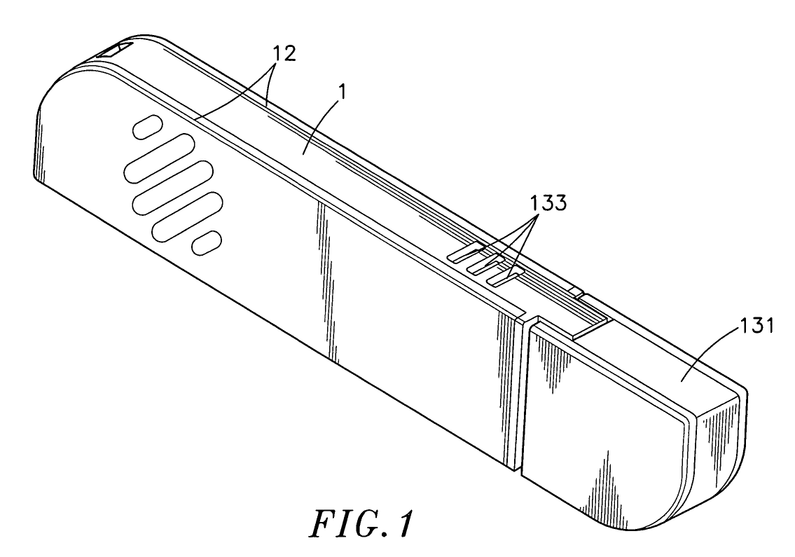

Referring to FIGS. 1˜3, a mobile video adapter stick in accordance with a first embodiment of the present invention is shown comprised of a housing 1, at least one circuit board 2, and a cooling fan 3.

The housing 1 is a narrow elongated hollow member, having an accommodation chamber 11, top and bottom covers 12 respectively covered on the top and bottom sides of the accommodation chamber 11, a connection portion 13 at the front end of the accommodation chamber 11, a transmission interface 132 mounted in the connection portion 13, a front cap 131 covered on the connection portion 13, a plurality of air vents 133 cut through the two opposite vertical lateral sidewalls thereof near the connection portion 13, and an adapter interface 134 provided at the rear side of the accommodation chamber 11 remote from the connection portion 13. The transmission interface 132 can be an electric connector, for example, a USB connector or IDE connector.

The circuit board 2 is mounted in the accommodation chamber 11 inside the housing 1, having a video processing chip 21, a plurality of electronic component parts 22 and the related circuit means respectively arranged on the top and bottom sides thereof.

The cooling fan 3 is mounted in the accommodation chamber 11 near the rear side of the housing 1 and remote from the air vents 133, having an air output port 31 for output of induced currents of air toward the circuit board 2.

During the assembly, the circuit board 2 and the cooling fan 3 are mounted in the accommodation chamber 11 inside the housing 1, and then the transmission interface 132 and the adapter interface 134 are respectively electrically connected to the circuit board 2, and then the top and bottom covers 12 and the front cap 131 are respectively covered on the top and bottom sides of the accommodation chamber 11 and the connection portion 13. When the mobile video adapter stick is assembled, the cooling fan 3 is disposed inside the accommodation chamber 11 near the rear side of the housing 1 with the air output port 31 abutted against the rear side of the circuit board 2. Further, the transmission interface 132 extends out of the front side of the connection portion 13 of the housing 1 for connection to a corresponding port in a computer. As indicated in the drawings, the mobile video adapter stick has light, thin, short and small characteristics, convenient for storage, carrying, use, maintenance and replacement.

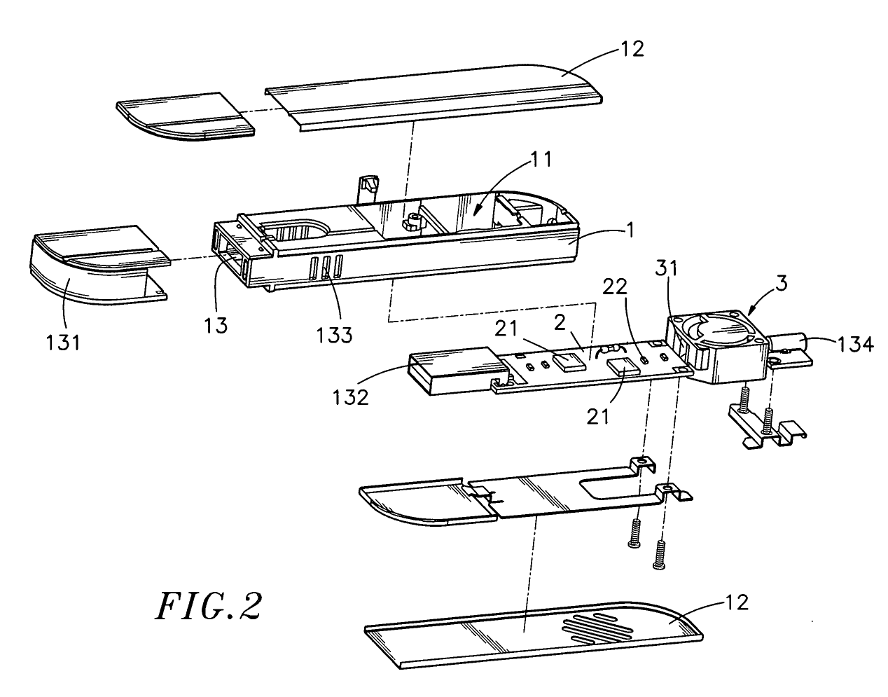

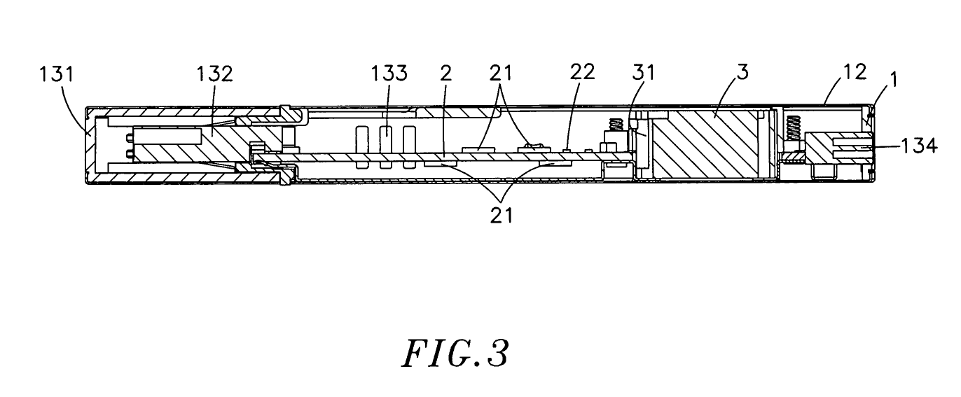

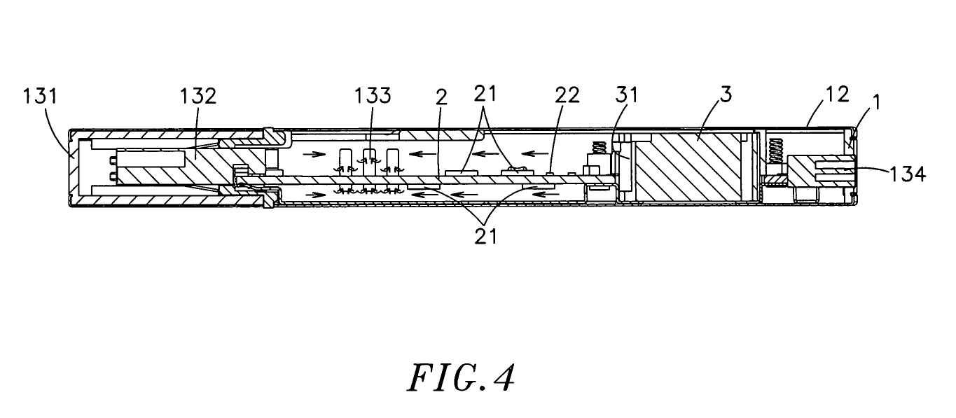

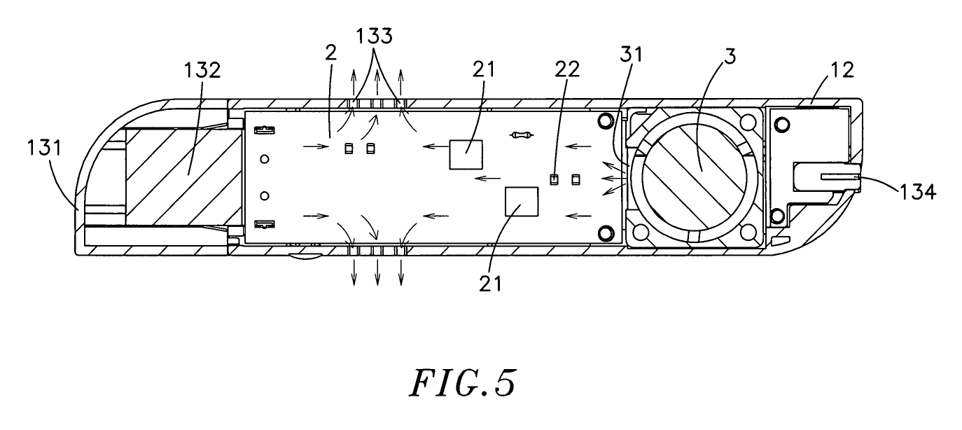

Referring to FIGS. 4 and 5 and FIGS. 2 and 3 again, when in use, the front cap 131 is removed from the connection portion 13 of the housing 1, and then the transmission interface 132 is inserted into the corresponding port in the computer, and then the adapter interface 134 is connected to the A/V signal line. Thus, audio and video signals can be inputted into the circuit board 2 through the A/V signal line and the adapter interface 134 for processing, so that processed audio and video signals can be transmitted to the computer through the transmission interface 132 for output. During signal processing operation, the video processing chip 21 generates heat at about 85° C.˜89° C. This high temperature must be quickly lower to keep normal functioning of the video processing chip 21. At this time, the cooling fan 3 is turned on to cause currents of air over the circuit board 2 toward the connection portion 13 and the air vents 133, and therefore heat energy is carried with the continuously flowing currents of air out of the housing 1 through the air vents 133, lowering the operating temperature of the video processing chip 21 to about 65° C.˜80° C. and the ambient temperature to about 40° C.˜50° C., preventing malfunctioning of the video processing chip 21 or deformation of various surrounding plastic structures. Therefore, the use of the cooling fan 3 greatly prolongs the working life of the video processing chip 21.

Alternatively, the cooling fan 3 can be an induced-draft fan to draw outside cold air into the inside of the accommodation chamber 11 through the air vents 133 toward the top and bottom sides of the circuit board 2 and then the rear side of the housing 1. In this case, an air outlet is provided at the rear side of the housing 1 for output of the induced draft of air.

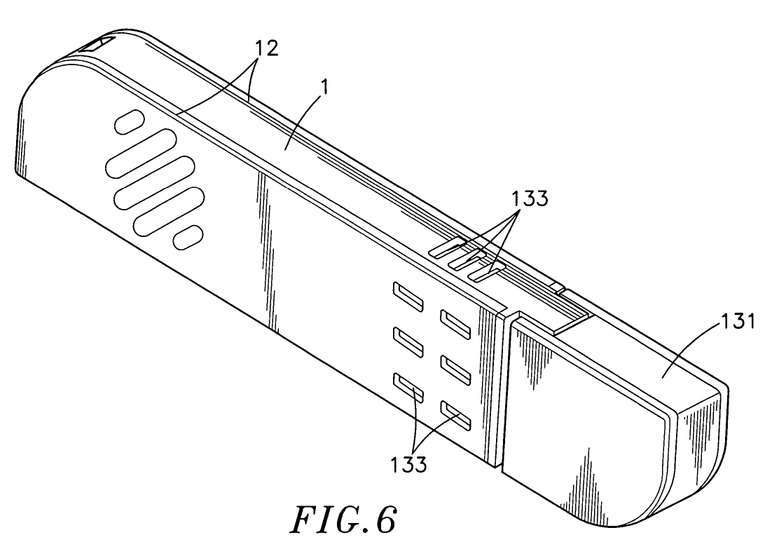

FIG. 6 is an elevational view of a mobile video adapter stick in accordance with a second embodiment of the present invention. According to this second embodiment, the housing 1 has air vents 133 on the two opposite vertical lateral sidewalls as well as the top and bottom walls (top and bottom covers) so that air is circulated through the housing 1 when the cooling fan 3 is turned on to blow air toward the circuit board 2 (or to draw outside cold air into the inside of the housing 1).

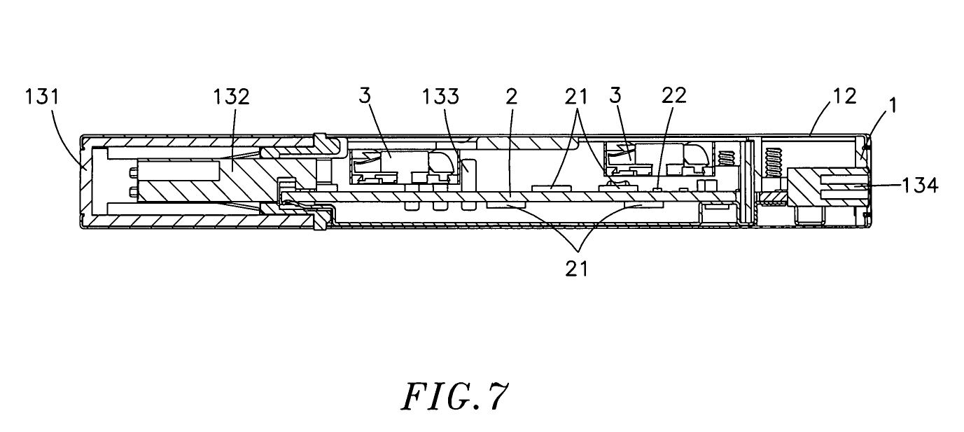

FIG. 7 is a sectional side view of a mobile video adapter stick in accordance with a third embodiment of the present invention. According to this embodiment, the mobile video adapter stick comprises two cooling fans 3. One cooling fan 3 is set adjacent to the air vents 133, and the other cooling fan 3 is set abutted against the rear side edge of the circuit board 2 remote from the air vents 133. These two cooling fans 3 include one blower fan and one induced-draft fan. The use of these two cooling fans 3 enhances circulation of air through the housing 1, thereby efficiently lowering the inside temperature of the housing 1.

As indicated above, the invention provides a mobile video adapter stick, which has the following benefits:

1. The mobile video adapter stick is small-sized convenient for connection to a computer without interfering with the installation of other peripheral apparatus. Mounting or dismounting of the mobile video adapter stick needs not to detach the computer.

2. The mobile video adapter stick uses a cooling fan to dissipate heat from the internal circuit board, keeping normal functioning of the internal component parts and preventing accumulation of heat energy that may affect the operation of surrounding electronic devices.

3. The mobile video adapter stick is small-sized, convenient to install, and inexpensive to manufacture.

4. The mobile video adapter stick uses a cooling fan to dissipate heat from the accommodation chamber, thereby prolonging the working life of the internal circuit board and lowering the possibility of device failure.

5. The mobile video adapter stick has light, thin, short and small characteristics, convenient for storage, carrying, use, maintenance and replacement.

A prototype of mobile video adapter stick has been constructed with the features of FIGS. 1˜7. The mobile video adapter stick functions smoothly to provide all of the features discussed earlier.

Although particular embodiments of the invention have been described in detail for purposes of illustration, various modifications and enhancements may be made without departing from the spirit and scope of the invention. For example, the housing can be directly injection-molded from plastics in integrity. Alternatively, the housing can be composed of a number of plastic parts. Accordingly, the invention is not to be limited except as by the appended claims.

What is claimed is:

1. A mobile video adapter stick comprising:
a housing, said housing having an accommodation chamber, a connection portion disposed at a front side of said accommodation chamber, a transmission interface set in said connection portion for connection to a computer, a plurality of air vents disposed adjacent to said connection portion in communication between said accommodation chamber and the atmosphere, and an adapter interface disposed at a rear side of said accommodation chamber and connectable to an audio and video signal source;
a circuit board mounted in said accommodation chamber inside said housing and electrically connected to said transmission interface and said adapter interface for processing inputted audio and video signals received from said adapter interface for output through said transmission interface, said circuit board comprising at least one video processing chip; and
at least one cooling fan mounted in said accommodation chamber inside said housing for cooling said at least one video processing chip and said circuit board.

2. The mobile video adapter stick as claimed in claim 1, wherein said housing further comprises a top cover and a bottom cover respectively covered on top and bottom sides of said accommodation chamber.

3. The mobile video adapter stick as claimed in claim 2, wherein said top cover and said bottom cover are metal covers.

4. The mobile video adapter stick as claimed in claim 1, wherein said transmission interface extends out of a front side of said connection portion.

5. The mobile video adapter stick as claimed in claim 1, wherein said transmission interface is an electric connector.

6. The mobile video adapter stick as claimed in claim 5, wherein said electric connector is an USB connector.

7. The mobile video adapter stick as claimed in claim 5, wherein said electric connector is an IDE connector.
